(19) United States
(12) Patent Application Publication
(10) Pub. No.: US 2017/0148405 A1
(43) Pub. Date: May 25, 2017

(54) ARRAY SUBSTRATE AND DISPLAY DEVICE

(71) Applicant: Wuhan China Star Optoelectronics Technology Co., Ltd., Wuhan, Hubei (CN)

(72) Inventors: Zhenzhou Xing, Wuhan, Hubei (CN); Qingcheng Zuo, Wuhan, Hubei (CN); Yujie Bai, Wuhan, Hubei (CN)

(73) Assignee: Wuhan China Star Optoelectronics Technology Co., Ltd., Wuhan, Hubei (CN)

(21) Appl. No.: 14/786,028

(22) PCT Filed: May 25, 2015
(86) PCT No.: PCT/CN2015/079747

§ 371 Date: Dec. 31, 2015

(30) Foreign Application Priority Data
May 11, 2015 (CN) 201510236096.6

(51) Int. Cl. G09G 3/36

(52) U.S. Cl. CPC G09G 3/3677; G09G 3/3688; G09G 2310/06

(57) ABSTRACT

An array substrate and a display device are disclosed. The present disclosure relates to the technical field of display, whereby the technical problem that the uniformity of the image of the liquid crystal display panel is affected by the distortion of the source driving signal can be solved.

### CROSS REFERENCE TO RELATED APPLICATION

The present application claims benefit of Chinese patent application CN 201510236096.6, entitled “Array Substrate and Display Device” and filed on May 11, 2015, the entirety of which is incorporated herein by reference.

### FIELD OF THE INVENTION

The present disclosure relates to the technical field of display, and particularly to an array substrate and a display device.

### BACKGROUND OF THE INVENTION

A source driving signal can be obtained from image signals that are in serial arrangement after conversion, and must have the features concerning driving image display of the liquid crystal display panel. On the one hand, the source driving signal must be a parallel signal with one row as a unit. On the other hand, an amplitude change of the source driving signal must conform to the light transmittance property of the liquid crystal molecules after Gamma correction. A source driving circuit is used for converting the image signal into the source driving signal with the above features.

As shown in FIG. 1, the source driving circuit is arranged on an array substrate. The source driving circuit comprises D₁ to Dᵢ data lines (in total of i data lines, i being any integer larger than 1), which are used for providing the source driving signal to each pixel unit, and G₁ to Gⱼ gate lines (in total of j gate lines, j being any integer larger than 1). The gate lines and the data lines cooperate with each other, whereby the liquid crystal display panel can be driven to display images. However, since each output end of the source driving circuit corresponds to one column of pixel units of the array substrate, and each column of pixel units of the array substrate can be equivalent to the Resistor-Capacitor circuit (RC circuit) as shown in FIG. 2, a delay distortion would occur to the waveform of the source driving signal output by the source driving circuit during transmission. As shown in FIG. 3, the solid line is an original waveform of the source driving signal, and the dotted line is a distorted waveform of the source driving signal. It is obvious that, not only the shape of the distorted waveform of the source driving signal changes, but also the amplitude thereof is smaller than that of the original waveform. The uniformity of the image of the liquid crystal display panel would be affected by the distortion of the source driving signal. Consequently, a distortion would occur to the images of the liquid crystal display panel, and thus the display effect thereof would be affected.

### SUMMARY OF THE INVENTION

The present disclosure aims to provide an array substrate and a display device so as to solve the technical problem that the uniformity of the images of the liquid crystal display panel is affected by the distortion of the source driving signal.

The present disclosure first provides an array substrate, which comprises n active areas that are arranged from top to bottom in vertical direction, each active area comprising m rows of pixel units, n and m both being any integers larger than 1, wherein each active area is provided with a source driving circuit correspondingly, which provides a source driving signal to each row of pixel units of said active area.

The array substrate is provided with a gate driving circuit, which is provided with m output ends; and each output end outputs n gate driving signals simultaneously, each of which is used for driving one row of pixel units of n active areas.

The gate driving circuit comprises a first to an m^{th} output ends from top to bottom, and each active area comprises a first to an m^{th} rows of pixel units from top to bottom; and the first, the second, . . . , the (m−1)^{th}, and the m^{th} output ends of the gate driving circuit are connected with the first, the second, . . . , the (m−1)^{th}, and the m^{th} rows of pixel units of each active area respectively.

The gate driving circuit comprises a first to an m^{th} output ends from top to bottom, and each active area comprises a first to an m^{th} rows of pixel units from top to bottom; and the first, the second, . . . , the (m−1)^{th}, and the m^{th} output ends of the gate driving circuit are connected with the m^{th}, the (m−1)^{th}, . . . , the second, and the first rows of pixel units of each active area respectively.

The gate driving circuit comprises a first to an m^{th} output ends from top to bottom, and each active area comprises a first to an m^{th} rows of pixel units from top to bottom; and the first, the second, . . . , the (m−1)^{th}, and the m^{th} output ends of the gate driving circuit are connected with the m^{th}, the (m−1)^{th}, . . . , the second, and the first rows of pixel units of odd-numbered active areas of the n active areas respectively, and the first, the second, . . . , the (m−1)^{th}, and the m^{th} output ends of the gate driving circuit are connected with the first, the second, . . . , the (m−1)^{th}, and the m^{th} rows of pixel units of even-numbered active areas of the n active areas respectively.

The gate driving circuit comprises a first to an m^{th} output ends from top to bottom, and each active area comprises a first to an m^{th} rows of pixel units from top to bottom; and the first, the second, . . . , the (m−1)^{th}, and the m^{th} output ends of the gate driving circuit are connected with the first, the second, . . . , the (m−1)^{th}, and the m^{th} rows of pixel units of odd-numbered active areas of the n active areas respectively, and the first, the second, . . . , the (m−1)^{th}, and the m^{th} output ends of the gate driving circuit are connected with the m^{th}, the (m−1)^{th}, . . . , the second, and the first rows of pixel units of even-numbered active areas of the n active areas respectively.

The n source driving circuits are all arranged at an upper end or a lower end of the array substrate.

The n source driving circuits are arranged at an upper end and a lower end of the array substrate respectively.

The source driving circuit increases an amplitude of the source driving signal.

The following beneficial effects can be brought about by the present disclosure. Since each active area is provided with a source driving circuit correspondingly, the transmission distance of the source driving signal of each source driving circuit can be shortened to a large extent compared with the transmission distance in the prior art. With respect to the pixel units that are far from the source driving circuit, the extent of delay, attenuation, and distortion of the waveform of the source driving signal received therein can be reduced. Therefore, the uniformity of the image of the liquid crystal display panel that is provided with the array substrate can be improved.

The embodiment of the present disclosure further provides a display device, which comprises the aforesaid array substrate.

Other features and advantages of the present disclosure will be further explained in the following description, and partially become self-evident therefrom, or be understood through the embodiments of the present disclosure. The objectives and advantages of the present disclosure will be achieved through the structure specifically pointed out in the description, claims, and the accompanying drawings.

### BRIEF DESCRIPTION OF THE DRAWINGS

The drawings necessary for explaining the embodiments are introduced briefly below to illustrate the technical solutions of the embodiments of the present disclosure more clearly.

FIG. 1 schematically shows a structure of an array substrate in detail in the prior art;

FIG. 2 is an equivalent circuit diagram of the array substrate in the prior art;

FIG. 3 schematically shows waveforms of a source driving signal before and after distortion in the prior art;

FIG. 4 schematically shows a structure of an array substrate according to an embodiment of the present disclosure;

FIG. 5 and FIG. 6 schematically show the structures of the array substrates in detail according to the embodiments of the present disclosure; and

FIG. 7 schematically shows waveforms of a source driving signal before and after distortion according to an embodiment of the present disclosure.

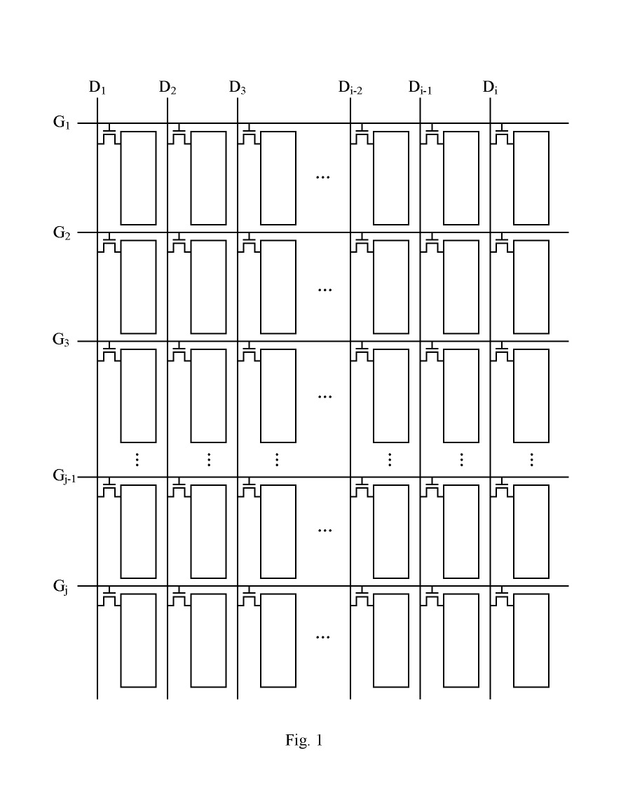

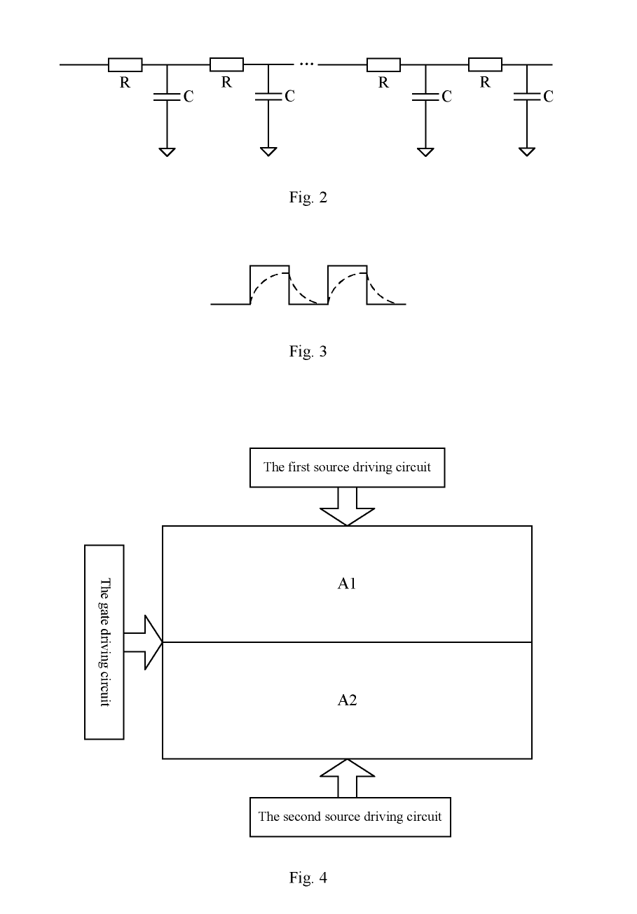

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It should be noted that, as long as there is no structural conflict, all the technical features mentioned in all the embodiments may be combined together in any manner, and the technical solutions obtained in this manner all fall within the scope of the present disclosure.

An embodiment of the present disclosure provides an array substrate, which comprises n active areas that are arranged from top to bottom in vertical direction, each active area comprising m rows of pixel units, n and m both being any integers larger than 1, wherein each active area is provided with a corresponding source driving circuit, which provides a source driving signal to each row of pixel units of the active area.

In order to facilitate the description, the technical solution of the present disclosure will be illustrated specifically and in detail hereinafter taking n=2 as an example. The specific structure of the array substrate would change accordingly if the number of n changes, but the technical solutions obtained therein all fall within the scope of the present disclosure.

As shown in FIG. 4, the array substrate comprises two active areas that are arranged from top to bottom in vertical direction, i.e., an active area A1 and an active area A2. Each active area is provided with a source driving circuit correspondingly. That is, the active area A1 is provided with a first source driving circuit that is used for providing a source driving signal for A1, and the active area A2 is provided with a second source driving circuit that is used for providing a source driving signal for A2.

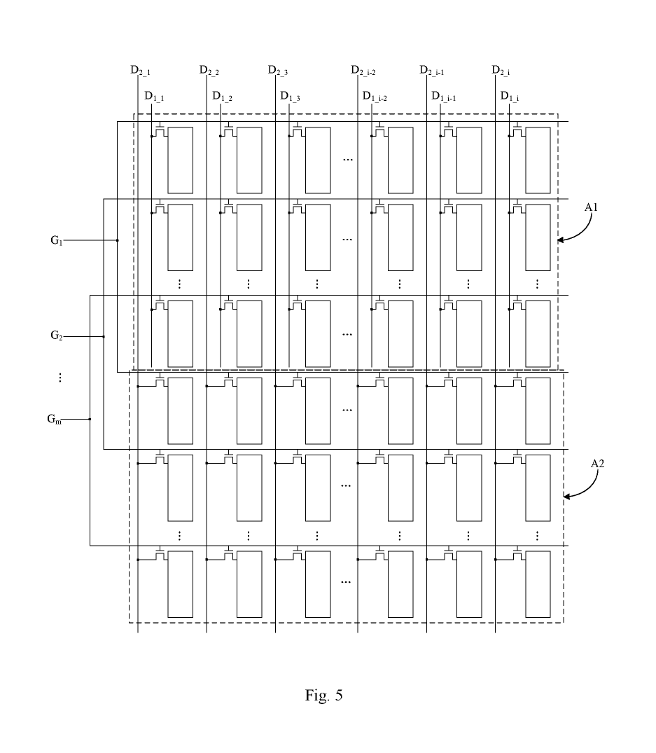

The first source driving circuit and the second source driving circuit can be arranged at one end of an upper end and a lower end of the array substrate side by side. Specifically, if the array substrate is provided with i columns of pixel units, as shown in FIG. 5, the first source driving circuit corresponds to data lines to D₁_{_}₁ to D₁_{_}ᵢ, and the second source driving circuit corresponds to data lines D₂_{_}₁ to D₂_{_}ᵢ. The first source driving circuit and the second source driving circuit are all arranged at the upper end of the array substrate, and thus the data lines D₁_{_}₁ to D₁_{_}ᵢ and D₂_{_}₁ to D₂_{_}ᵢ all extend from the upper end of the array substrate, and provide a corresponding source driving signal to each column of pixel units.

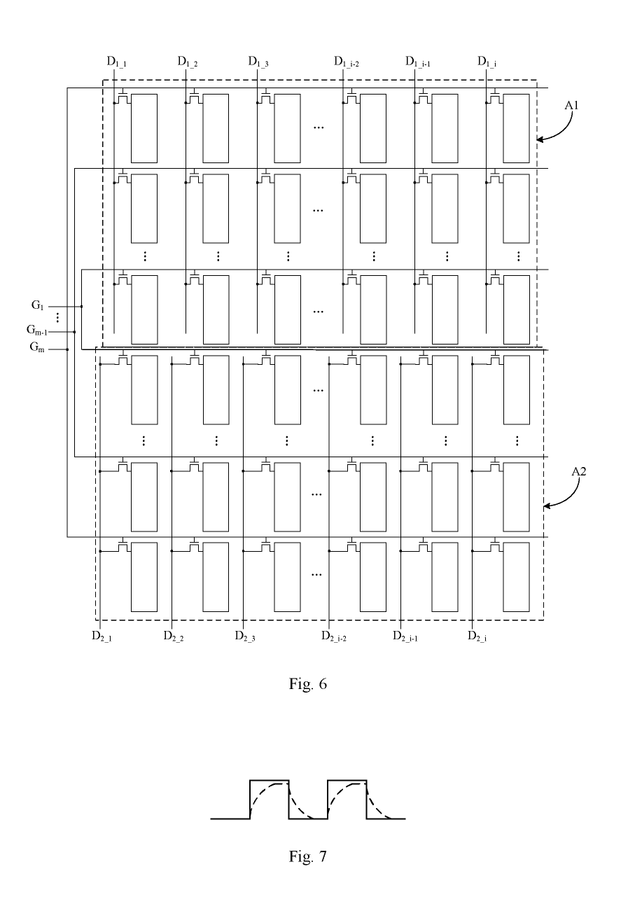

In addition, as shown in FIG. 6, the first source driving circuit and the second source driving circuit can be arranged at the upper end and the lower end of the array substrate respectively. The first source driving circuit is arranged near to the corresponding active area A1, and the second source driving circuit is arranged near to the corresponding active area A2. In this case, the lengths of the data lines extending from the first source driving circuit and the second source driving circuit can be shortened to a large extent compared with those in the prior art. Moreover, compared with the array substrate as shown in FIG. 5, the number of wirings in the active area A1 of the array substrate as shown in FIG. 6 can be reduced, and thus the light transmittance of the active area A1 can be improved.

Since each active area is provided with a source driving circuit correspondingly, the transmission distance of the source driving signal of each source driving circuit can be shortened to a large extent compared with the transmission distance in the prior art. With respect to the pixel units that are far from the source driving circuit, the waveform of the source driving signal received therein is the distorted waveform as shown by the dotted line in FIG. 7. Compared with the distorted waveform as shown in FIG. 3, the extent of delay, attenuation, and distortion of the distorted waveform as shown in FIG. 7 relative to the original waveform as shown by the solid line can be reduced, and thus the uniformity of the image of the liquid crystal display panel can be improved.

Moreover, an amplitude of the source driving signal output by the source driving circuit can be increased reasonably according to the extent of attenuation of the source driving signal received by each row of pixel units with a different distance from the source driving circuit, so that the amplitude of the source driving signal received by the pixel units after the attenuation of the source driving signal during transmission is equal to the amplitude of the source driving signal which the pixel units should receive theoretically. In this case, the extent of distortion of the distorted waveform can be further reduced, and thus the display effect of the liquid crystal display panel can be further improved.

The active area A1 and the active area A2 can be driven by two gate driving circuits respectively, and perform scanning and display images from top to bottom in sequence. The active area A1 and the active area A2 can also be driven by the same gate driving circuit, and perform the line-by-line scanning and display images at the same time. With respect to the active area that is provided with m rows of pixel units, the gate driving circuit comprises m output ends. In order to drive the active area A1 and the active area A2 at the same time, each output end of the gate driving circuit outputs two gate driving signals at the same time, and each active area receives one gate driving signal. In this case, the active area A1 and the active area A2 can be driven by the two gate driving signals at the same time to perform the line-by-line scanning and display images, and the scanning rate of the array substrate can be improved with the cooperation of the source driving signals output by the two source driving circuits respectively.

For example, as shown in FIG. 5, the gate driving circuit comprises a first to an m^{th} output ends G₁ to Gₘ from top to bottom, and the active area A1 and the active area A2 also comprise a first to an m^{th} rows of pixel units from top to bottom. The first output end G₁ of the gate driving circuit is connected with the first row of pixel units of the active area A1 and the first row of pixel units of the active area A2. Similarly, the second output end G₂ of the gate driving circuit is connected with the second rows of pixel units of the active areas A1 and A2. Accordingly, the (m−1)^{th} output end of the gate driving circuit is connected with the (m−1)^{th} rows of pixel units of the active areas A1 and A2, and the m^{th} output end of the gate driving circuit is connected with the m^{th} rows of pixel units of A1 and A2.

It is obvious that, the situation as shown in FIG. 5 can be extended. With respect to the array substrate having n active areas, the first, the second, . . . , the (m−1)^{th}, and the m^{th} output ends of the gate driving circuit are connected with the first, the second, . . . , the (m−1)^{th}, and the m^{th} rows of pixel units of each active area in sequence. In addition, the corresponding relationship between the output ends of the gate driving circuit and each row of pixel units of the active areas can be changed simply, i.e., the first, the second, . . . , the (m−1)^{th}, and the m^{th} output ends of the gate driving circuit can be connected with the m^{th}, the (m−1)^{th}, . . . , the second, and the first rows of pixel units of each active area in sequence.

For another example, as shown in FIG. 6, the gate driving circuit comprises a first to an m^{th} output ends G₁ to Gₘ from top to bottom, and the active area A1 and the active area A2 also comprise a first to an m^{th} rows of pixel units from top to bottom. Here, with respect to the active area A1, the corresponding relationship between each row of pixel units and the output ends of the gate driving circuit is opposite to the situation as shown in FIG. 5; while with respect to the active area A2, the corresponding relationship between each row of pixel units and the output ends of the gate driving circuit is the same as the situation as shown in FIG. 5. That is, the m^{th} output end Gₘ of the gate driving circuit is connected with the first row of pixel units of the active area A1 and the last row (i.e., the m^{th} row) of pixel units of the active area A2; and similarly, the (m−1)^{th} output end Gₘ₋₁ of the gate driving circuit is connected with the second row of pixel units of the active area A1 and the last but one row (i.e., the (m−1)^{th} row) of pixel units of the active area A2. Accordingly, the first output end G₁ of the gate driving circuit is connected with the m^{th} row of pixel units of the active area A1 and the first row of pixel units of the active area A2.

It is obvious that, the situation as shown in FIG. 6 can also be extended. With respect to the array substrate having n active areas, the first, the second, . . . , the (m−1)^{th}, and the m^{th} output ends of the gate driving circuit are connected with the m^{th}, the (m−1)^{th}, . . . , the second, and the first rows of pixel units of odd-numbered active areas of the n active areas in sequence, and the first, the second, . . . , the (m−1)^{th}, and the m^{th} output ends of the gate driving circuit are connected with the first, the second, . . . , the (m−1)^{th}, and the m^{th} rows of pixel units of even-numbered active areas of the n active areas in sequence. In addition, the corresponding relationship between the output ends of the gate driving circuit and each row of pixel units of the active areas can be changed simply, i.e., the first, the second, . . . , the (m−1)^{th}, and the m^{th} output ends of the gate driving circuit are connected with the first, the second, . . . , the (m−1)^{th}, and the m^{th} rows of pixel units of odd-numbered active areas of the n active areas in sequence, and the first, the second, . . . , the (m−1)^{th}, and the m^{th} output ends of the gate driving circuit are connected with the m^{th}, the (m−1)^{th}, . . . , the second, and the first rows of pixel units of even-numbered active areas of the n active areas in sequence.

In the array substrate according to the embodiment of the present disclosure, the line-by-line scanning of each active area can be performed at the same time, so that the image can be displayed. Thus, the more active areas there are, the higher the scanning rate of the array substrate would be. At the same time, the lighter the distortion phenomenon of the source driving signal would be, and the better the uniformity of the liquid crystal display panel would become. However, the more active areas there are, the higher the cost of the array substrate would be, and the more complicated the wirings thereof would become. Therefore, the array substrate comprising two active areas is the optimized design taking the aforesaid factors into comprehensive consideration.

Further, the embodiment of the present disclosure provides a display device, which comprises any one of the above array substrates. The display device can be liquid crystal television, liquid crystal display device, mobile phone, tablet personal computer, and so on.

The above embodiments are described only for better understanding, rather than restricting, the present disclosure. Any person skilled in the art can make amendments to the implementing forms or details without departing from the spirit and scope of the present disclosure. The protection scope of the present disclosure shall be determined by the scope as defined in the claims.

1. An array substrate, comprising n active areas that are arranged from top to bottom in vertical direction, each active area comprising m rows of pixel units, n and m both being any integers larger than 1,
wherein each active area is provided with a source driving circuit correspondingly, which provides a source driving signal to each row of pixel units of said active area.

2. The array substrate according to claim 1, wherein the array substrate is provided with a gate driving circuit, which is provided with m output ends; and
wherein each output end outputs n gate driving signals simultaneously, each of which is used for driving one row of pixel units of n active areas.

3. The array substrate according to claim 2, wherein the gate driving circuit comprises a first to an m^{th} output ends from top to bottom, and each active area comprises a first to an m^{th} rows of pixel units from top to bottom; and
wherein the first, the second, . . . , the (m−1)^{th}, and the m^{th} output ends of the gate driving circuit are connected with the first, the second, . . . , the (m−1)^{th}, and the m^{th} rows of pixel units of each active area respectively.

4. The array substrate according to claim 2, wherein the gate driving circuit comprises a first to an m^{th} output ends from top to bottom, and each active area comprises a first to an m^{th} rows of pixel units from top to bottom; and
wherein the first, the second, . . . , the (m−1)^{th}, and the m^{th} output ends of the gate driving circuit are connected with the m^{th}, the (m−1)^{th}, . . . , the second, and the first rows of pixel units of each active area respectively.

5. The array substrate according to claim 2, wherein the gate driving circuit comprises a first to an m^{th} output ends from top to bottom, and each active area comprises a first to an m^{th} rows of pixel units from top to bottom; and
wherein the first, the second, . . . , the (m−1)^{th}, and the m^{th} output ends of the gate driving circuit are connected with the m^{th}, the (m−1)^{th}, . . . , the second, and the first rows of pixel units of odd-numbered active areas of the n active areas respectively, and the first, the second, . . . , the (m−1)^{th}, and the m^{th} output ends of the gate driving circuit are connected with the first, the second, . . . , the (m−1)t^{h}, and the m^{th} rows of pixel units of even-numbered active areas of the n active areas respectively.

6. The array substrate according to claim 2, wherein the gate driving circuit comprises a first to an m^{th} output ends from top to bottom, and each active area comprises a first to an m^{th} rows of pixel units from top to bottom; and
wherein the first, the second, . . . , the (m−1)^{th}, and the m^{th} output ends of the gate driving circuit are connected with the first, the second, . . . , the (m−1)^{th}, and the m^{th} rows of pixel units of odd-numbered active areas of the n active areas respectively, and the first, the second, . . . , the (m−1)^{th}, and the m^{th} output ends of the gate driving circuit are connected with the m^{th}, the (m−1)^{th}, . . . , the second, and the first rows of pixel units of even-numbered active areas of then active areas respectively.

7. The array substrate according to claim 1, wherein the n source driving circuits are all arranged at an upper end or a lower end of the array substrate.

8. The array substrate according to claim 1, wherein the n source driving circuits are arranged at an upper end and a lower end of the array substrate respectively.

9. The array substrate according to claim 1, wherein the source driving circuit increases an amplitude of the source driving signal.

10. A display device, comprising an array substrate,
wherein the array substrate comprises n active areas that are arranged from top to bottom in vertical direction, each active area comprising m rows of pixel units, n and m both being any integers larger than 1; and
wherein each active area is provided with a source driving circuit correspondingly, which provides a source driving signal to each row of pixel units of said active area.

11. The display device according to claim 10, wherein the array substrate is provided with a gate driving circuit, which is provided with m output ends; and
wherein each output end outputs n gate driving signals simultaneously, each of which is used for driving one row of pixel units of n active areas.

12. The display device according to claim 11, wherein the gate driving circuit comprises a first to an m^{th} output ends from top to bottom, and each active area comprises a first to an m^{th} rows of pixel units from top to bottom; and
wherein the first, the second, . . . , the (m−1)^{th}, and the m^{th} output ends of the gate driving circuit are connected with the first, the second, . . . , the (m−1)^{th}, and the m^{th} rows of pixel units of each active area respectively.

13. The display device according to claim 11, wherein the gate driving circuit comprises a first to an m^{th} output ends from top to bottom, and each active area comprises a first to an m^{th} rows of pixel units from top to bottom; and
wherein the first, the second, . . . , the (m−1)^{th}, and the m^{th} output ends of the gate driving circuit are connected with the m^{th}, the (m−1)^{th}, . . . , the second, and the first rows of pixel units of each active area respectively.

14. The display device according to claim 11, wherein the gate driving circuit comprises a first to an m^{th} output ends from top to bottom, and each active area comprises a first to an m^{th} rows of pixel units from top to bottom; and
wherein the first, the second, . . . , the (m−1)^{th}, and the m^{th} output ends of the gate driving circuit are connected with the m^{th}, the (m−1)^{th}, . . . , the second, and the first rows of pixel units of odd-numbered active areas of the n active areas respectively, and the first, the second, . . . , the (m−1)^{th}, and the m^{th} output ends of the gate driving circuit are connected with the first, the second, . . . , the (m−1)^{th}, and the m^{th} rows of pixel units of even-numbered active areas of the n active areas respectively.

15. The display device according to claim 11, wherein the gate driving circuit comprises a first to an m^{th} output ends from top to bottom, and each active area comprises a first to an m^{th} rows of pixel units from top to bottom; and
wherein the first, the second, . . . , the (m−1)^{th}, and the m^{th} output ends of the gate driving circuit are connected with the first, the second, . . . , the (m−1)^{th}, and the m^{th} rows of pixel units of odd-numbered active areas of the n active areas respectively, and the first, the second, . . . , the (m−1)^{th}, and the m^{th} output ends of the gate driving circuit are connected with the m^{th}, the (m−1)^{th}, . . . , the second, and the first rows of pixel units of even-numbered active areas of the n active areas respectively.

16. The display device according to claim 10, wherein the n source driving circuits are all arranged at an upper end or a lower end of the array substrate.

17. The display device according to claim 10, wherein the n source driving circuits are arranged at an upper end and a lower end of the array substrate respectively.

18. The display device according to claim 10, wherein the source driving circuit increases an amplitude of the source driving signal.
